(19) United States
(12) Patent Application Publication
(10) Pub. No.: US 2006/0197920 A1
(43) Pub. Date: Sep. 7, 2006

(54) Projector and method of controlling the same

(75) Inventors: Shiki Furui, Matsumoto-Shi (JP); Chiharu Akiyama, Suwa-Shi (JP); Yuji Mochizuki, Shiojiri-Shi (JP); Osamu Kumamoto, Azumino-Shi (JP); Shunji Maruyama, Azumino-Shi (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 11/348,302

(22) Filed: Feb. 7, 2006

(30) Foreign Application Priority Data
Mar. 7, 2005 (JP) 2005-062013

(51) Int. Cl. G03B 21/14

(52) U.S. Cl. 353/69

(57) ABSTRACT

A projector in which an image signal is inputted to project an optical image corresponding to the image signal and display the image on a projection surface, the projector including: an optical modulation unit having an area capable of modulation where light can be modulated for modulating the light emitted from a light source in the area capable of modulation to form an optical image; a projection lens for enlarging and projecting the optical image formed in the optical modulation unit; a forming area changing unit capable of changing a size or a shape of a forming area for forming an optical image corresponding to the image signal in the area capable of optical modulation; an operation part capable of inputting location information indicating a projection location of the optical image corresponding to the image signal; and a forming area moving unit for moving the forming area on the basis of the location information inputted by means of the operation part when the forming area changed in size or shape by means of the forming area changing unit is movable in the area capable of optical modulation.

### BACKGROUND OF THE INVENTION

1. Technical Field

The present invention relates to a projector in which an image signal is inputted and an optical image corresponding to the image signal is projected, and a method of controlling the same.

2. Related Art

There has been a projector known in which light emitted from a light source is modulated by an optical modulation unit in accordance with an image signal to form an optical image and the optical image is enlarged and projected on a screen by a projection lens (JP-A-2002-365720, for example).

A projector disclosed in JP-A-2002-365720 is capable of adjusting a size of an image to be projected by means of an electronic zooming function (in which image size adjustment is carried out by utilizing not a lens but an electric circuit) on the basis of zoom designation by an operation by a user or the like.

The electronic zooming function is for performing a predetermined process for an inputted image signal to change the size of the area of an optical image (forming area) formed corresponding to the image signal, within the limits of the area where an optical image can be formed (area of possible modulation) in an optical modulation unit, and thereby, enabling a size of a projected image to be projected on a screen to be changed. In the electronic zooming function, the forming area is arranged to be enlarged or reduced with a predetermined position (center position, for example) in the area of possible modulation in the optical modulation unit being a reference point.

JP-A-2002-365720 is an example of related art.

In the projector disclosed in JP-A-2002-365720, the forming area is arranged to be enlarged or reduced with a center position of the area of possible modulation in the optical modulation unit being a reference point. Accordingly, when the projector is set so that a center position of the projected image is substantially accorded with a center position of the screen while the electronic zooming function is used for enlarging or reducing the forming area, the projected image is enlarged or reduced with the center position of the screen being a reference point.

Once a difference occurs between the center position of the projected image and the center position of the screen, however, a part of the projected image goes out of the screen after enlarging the projected image by using the electronic zooming function even when the projected image is in a size capable of projection on the screen, so that image size enlargement is limited. This causes a problem that settings of the projector must be readjusted for the purpose of correspondence between the center positions.

### SUMMARY

An advantage of the invention is to provide a projector capable of easily changing a location of a projected image and a method of controlling the same.

A projector according to an aspect of the invention is a projector in which an image signal is inputted and an optical image corresponding to the image signal is projected and displayed on a projection surface, the projector comprising:

an optical modulation unit having an area of possible modulation, which modulates the light emitted from a light source within the area of possible modulation to form an optical image;

a projection lens for enlarging and projecting the optical image formed in the optical modulation unit;

a forming area changing unit capable of changing a size or a shape of the forming area of an optical image corresponding to the image signal to be in the area capable of optical modulation;

an operation part capable of inputting location information indicating projection location of the optical image corresponding to the image signal; and

a forming area moving unit for moving the forming area on the basis of the location information inputted by the operation part when the forming area whose size or shape has been changed by the forming area changing unit is movable into the area of possible modulation.

In this projector, provided is a forming area moving unit for moving the forming area on the basis of the location information inputted by the operation part when the forming area, which has been changed in size or shape by the forming area changing unit, is movable in the area of possible modulation. This allows the projection location of the optical image to be changed by operating the operation part. Thus, the location of the projected image can be easily changed.

The projector is preferably provided with a notifying unit for notifying that the projection location of the optical image corresponding to the image signal can be changed, when the change in size or shape of the forming area made by the forming area changing unit allows the forming area to be moved in the area of possible modulation.

With this projector, because it has the notifying unit for notifying that the forming area is movable into the area of possible modulation, the user can easily know when the projected image is movable.

with this projector, it is preferable that the notifying unit incorporates in the projected image the information for displaying the image.

In this projector, the notifying unit incorporates in the projected image the information for displaying the projected image. Accordingly, the information can be read without taking one's eyes off the projected image.

A projector in accordance with another aspect of the invention is a projector in which an image signal is inputted and an optical image corresponding to the image signal is projected and displayed on a projection surface, the projector comprising:

an optical modulation unit having an area of possible modulation and which modulates the light emitted from a light source to the area of possible modulation, to form an optical image;

a projection lens for enlarging and projecting the optical image formed in the optical modulation unit;

a forming area changing unit capable of changing a size or a shape of a forming area of the optical image corresponding to the image signal so that the image is in the area of possible modulation;

an operation part capable of inputting location information indicating a projection location of the optical image corresponding to the image signal; and

a notifying unit for notifying that the projection location of the optical image corresponding to the image signal can be changed and for requesting input of the above referenced location information when the forming area whose size or shape has been changed by the forming area changing unit is movable in the area of possible modulation; and

a forming area moving unit for moving the forming area on the basis of the location information inputted by the operation part.

In this projector, the notifying unit requests input of the location information for the purpose of moving the forming area by the forming area moving unit when the forming area is movable in the area of possible modulation as a result of the size or shape of the forming area being changed by the forming area changing unit. Accordingly, a change in size or shape of the forming area and movement of the forming area can be carried out in succession, so that convenience in changing the location of the projected image is improved.

In the projector, the notifying unit preferably incorporates in the projected image the information for displaying the image.

In accordance with the projector, the notifying unit incorporates in the projected image the information for displaying the image. Accordingly, the contents of the information can be recognized without taking one's eyes off the projected image.

The projector preferably comprises a guiding unit for giving information of a location or a direction in which the optical image corresponding to the image signal can move when the forming area whose size or shape has been changed by the forming area changing unit is movable in the area of possible modulation.

In accordance with the invention, provided is the guiding unit for giving information of a location or a direction in which the forming area is movable. This allows the location or direction in which the forming area is movable to be easily recognized, so that convenience in changing a location of the projected image is further improved.

In the projector, the guiding unit preferably incorporates in the projected image the information for displaying the image.

In this projector, the information to be communicated is incorporated in the image to be projected and are displayed. Accordingly, the contents of the information can be recognized without taking one's eyes off the projected image.

A projector in accordance with another aspect of the invention is a projector in which an image signal is inputted and an optical image corresponding to the image signal is projected and displayed on a projection surface, the projector comprising:

an optical modulation unit having an area of possible modulation where light can be modulated, and which modulates the light emitted from a light source to the area of possible modulation to form an optical image;

a projection lens for enlarging and projecting the optical image formed in the optical modulation unit;

an operation part capable of inputting size information indicating a size or a shape of the optical image corresponding to the image signal and location information indicating a projection location of the optical image;

a forming area changing unit for changing a size or a shape of the forming area in order to form in the area capable of optical modulation an optical image corresponding to the image signal, in accordance with the size information inputted from the operation part;

a notifying unit for notifying that the projection location of the optical image corresponding to the image signal can be changed when the forming area whose size or shape has been changed by the forming area changing unit is movable in the area of possible modulation; and

a forming area moving unit for moving the forming area on the basis of the location information inputted by the operation part.

In this projector, the notifying unit requests input of the location information for moving the forming area by the forming area moving unit when the forming area is movable in the area of possible modulation as a result of the size or shape of the forming area being changed by the forming area changing unit on the basis of the size information inputted by the operation part. This allows a change in location of the projected image after change in size or shape of the projected image, so that convenience in changing the location of the projected image is improved.

A method of controlling a projector in accordance with an aspect of the invention is a method of controlling a projector comprising: an optical modulation unit having an area of possible modulation where light can be modulated, and which modulates the light emitted from a light source to the area of possible modulation to form an optical image; and a projection lens for enlarging and projecting the optical image formed by the optical modulation unit, the projector for projecting an optical image corresponding to an inputted image signal on a projection surface, the method including:

changing a size or a shape of a forming area in order to form an optical image corresponding to the image signal in the area of possible modulation;

inputting location information indicating a projection location of the optical image corresponding to the image signal; and

moving the forming area on the basis of the location information inputted when the forming area changed in size or shape is movable in the area of possible modulation.

In accordance with the method of controlling a projector, the forming area is moved on the basis of the location information inputted when the forming area which has been changed in size or shape is movable in the area of possible modulation. Accordingly, an operation for inputting the location information allows a projection location of the optical image to be changed. As a result, the location of the projected image can be easily changed.

A method of controlling a projector in accordance with another aspect of the invention is a method of controlling a projector comprising: an optical modulation unit having an area of possible modulation where light can be modulated and which modulates the light emitted from a light source to the area of possible modulation to form an optical image; a projection lens for enlarging and projecting the optical image formed by the optical modulation unit, and the projector for projecting an optical image corresponding to an inputted image signal on a projection surface, the method including:

changing a size or a shape of a forming area in order to form an optical image corresponding to the image signal in the area of possible modulation;

notifying that the projection location of the optical image corresponding to the image signal can be changed and requesting an input of location information indicating the projection location when the forming area which has been changed in size or shape is movable in the area of possible modulation;

inputting the location information; and

moving the forming area on the basis of the location information inputted.

In accordance with the method of controlling a projector, request for input of the location information is given for the purpose of moving the forming area when the forming area is movable in the area of possible modulation as a result of the change in size or shape of the forming area. This allows the change in size or shape of the forming area and the movement of the forming area to be carried out in succession, so that convenience in changing a location of the projected image is improved.

A method of controlling a projector in accordance with still another aspect of the invention is a method of controlling a projector comprising: an optical modulation unit having an area of possible modulation where light can be modulated and which modulates the light emitted from a light source to the area of possible modulation to form an optical image; and a projection lens for enlarging and projecting the optical image formed by the optical modulation unit, the projector projecting an optical image corresponding to an inputted image signal on a projection surface, the method including:

inputting size information indicating a size or a shape of the optical image corresponding to the image signal;

changing a size or shape of a forming area in order to form the optical image corresponding to the image signal in the area of possible modulation in accordance with the size information inputted;

notifying that the projection location of the optical image corresponding to the image signal can be changed and requesting an input of location information indicating the projection location when the forming area which has been changed in size or shape is movable in the area of possible modulation;

inputting the location information; and

moving the forming area on the basis of the location information inputted.

In accordance with the method of controlling a projector, request for input of the location information is given for the purpose of moving the forming area when the forming area is movable in the area of possible modulation as a result of the change in size or shape of the forming area made on the basis of the inputted size information. This allows a change in location of the projected image to be performed after change in size or shape of the projected image, so that convenience in changing the location of the projected image is improved.

Further, in the case that the above-mentioned projectors and the methods of controlling the same utilize a computer (a CPU) provided in the projector, the invention can be carried out by a program for achieving the function of the invention, a storage medium in which the program is stored so as to be readable by the computer, or the like. For the storage medium, used can be various kinds of media capable of reading by the computer such as a flexible disc, a CD-ROM, an optical-magnetic disc, an IC card, a ROM cartridge, a punch card, printed matter with a mark such as a bar code printed thereon, an internal storage unit of a projector (a memory such as a RAM, a ROM and the like), an external storage unit or the like.

### BRIEF DESCRIPTION OF THE DRAWINGS

The invention will be described with reference to the accompanying drawings, wherein like numbers reference like elements.

FIG. 1 is a schematic block diagram of a structure of a projector in accordance with an embodiment.

FIG. 2 illustrates in detail a structure of an optical unit.

FIG. 3 is a plan view of a liquid crystal light valve.

FIGS. 4A to 4E illustrate processes in an image processing part in accordance with size information.

FIGS. 5A to 5I illustrate processes in the image processing part in accordance with location information.

FIG. 6A is a front view of a projected image displayed on a screen in the case that an enlargement-reduction rate of an electronic zoom is 100%.

FIG. 6B is a front view of a projected image displayed on a screen in the case that an enlargement-reduction rate of an electronic zoom is below 100%.

FIG. 7 is a flowchart showing an operation in executing an electronic zooming function.

FIGS. 8A and 8B illustrate a projected image displayed in executing an electronic zooming function;

FIGS. 9A and 9B illustrate a projected image displayed in executing an electronic zooming function.

FIG. 10 illustrates a zooming operation for projection locations of a displayed image.

### DESCRIPTION OF EXEMPLARY EMBODIMENTS

Now, a projector in accordance with embodiments of the invention will be described, made reference to the drawings.

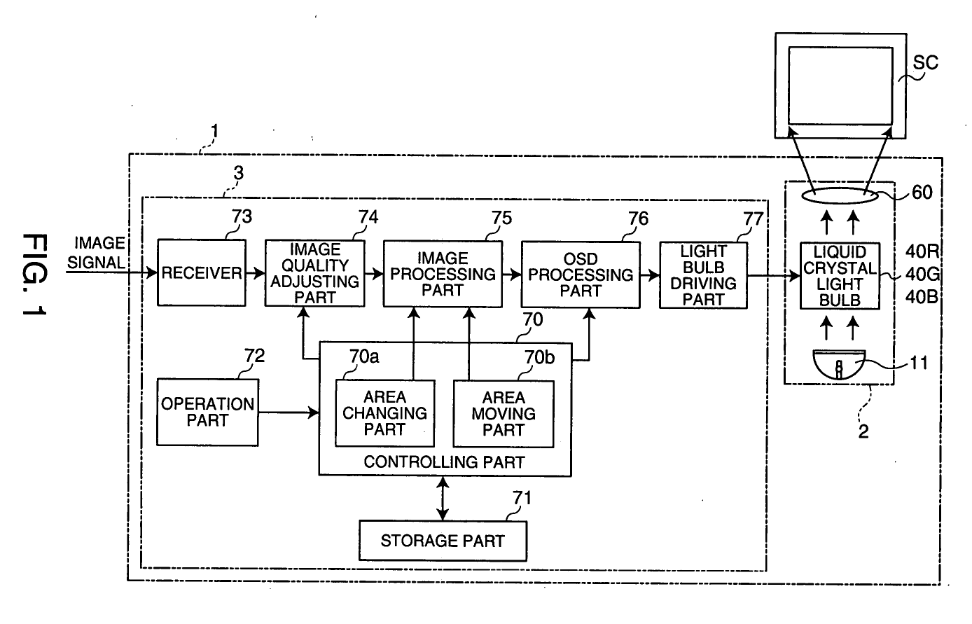

FIG. 1 is a schematic block diagram of a structure of a projector in accordance with an embodiment.

A projector 1 in the embodiment is for modulating light emitted from a light source in accordance with an image signal inputted from the outside to form an optical image and for enlarging and projecting the formed optical image on a screen. The projector 1 comprises an optical unit 2 and a controlling unit 3 as shown in FIG. 1.

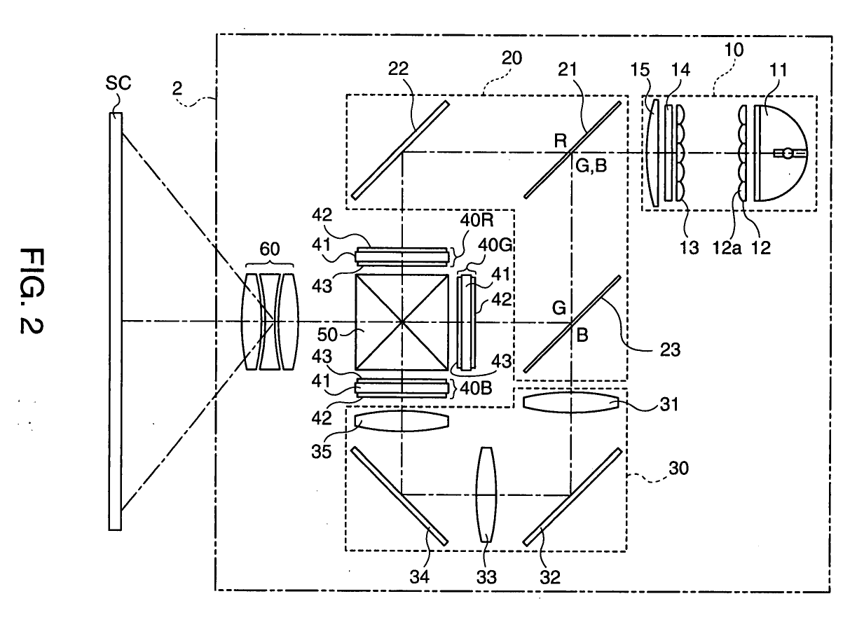

FIG. 2 illustrates in detail a structure of the optical unit 2. FIG. 2 shows an optical path along which the light emitted from the light source reaches the screen.

As shown in FIG. 2, the optical unit 2 comprises an illumination optical system 10, a color separating optical system 20, a relay optical system 30, three liquid crystal light valves 40R, 40G and 40B as an optical modulation unit, a cross dichroic prism 50 and a projection lens 60.

The illumination optical system 10 comprises a light source 11, a first lens array 12, a second lens array 13, a polarization converting element 14 and a superimposing lens 15. The luminous flux emitted from the light source 11 is divided into a plurality of minute luminous fluxes by the first lens array 12 in which small lenses 12a are provided in a matrix. The second lens array 13 and the super imposing lens 15 are provided so that all of the divided luminous fluxes illuminate all of the three liquid crystal light valves 40R, 40G and 40B to be illuminated. Accordingly, all the luminous fluxes are superimposed in the liquid crystal light valves 40R, 40G and 40B to substantially evenly illuminate all of the liquid crystal light valves 40R, 40G and 40B.

The polarization converting element 14 has a function to arrange unpolarized light from the light source 11 to be polarized light having a specific polarizing direction for the purpose of efficiently using the unpolarized light in the liquid crystal light valves 40R, 40G and 40B. The polarized light emitted from the illumination optical system 10 is incident on the light in color separating optical system 20.

The light in color separating optical system 20 divides the light emitted from the illumination optical system 10 into light in three colors having different wavelength ranges. A first dichroic mirror 21 transmits light in the substantially red color while it reflects light having a wavelength shorter than that of the transmitted light. The red light R transmitted by the first dichroic mirror 21 is reflected on a reflection mirror 22 to illuminate a liquid crystal light valve 40R for the red light.

The green light G of the light reflected on the first dichroic mirror 21 is reflected on a second dichroic mirror 23 to illuminate the liquid crystal light valve 40G for the green light. The blue light B is transmitted by the second dichroic mirror 23 and passes through the relay optical system 30 to illuminate the liquid crystal light valve 40B for the blue light.

An optical path of the blue light B is longer than optical paths of the light in other colors. Accordingly, a relay optical system 30 is provided in the optical path of the blue light B in order to keep down reduction in efficiency of illumination of the liquid crystal light valve 40B due to divergence of the luminous flux.

The relay optical system 30 comprises an incident-side lens 31, a first reflection mirror 32, a relay lens 33, a second reflection mirror 34 and an exit-side lens 35. The blue light B emitted from the light in color separating optical system 20 is converged in the vicinity of the relay lens 33 by the incident side lens 31 and then diverged in the direction of the exit-side lens 35.

Each of the liquid crystal light valves 40R, 40G and 40B comprises a liquid crystal panel 41, an incident-side polarizing plate 42 and an exit-side polarizing plate 43 and modulates the incident light to form an image (an optical image).

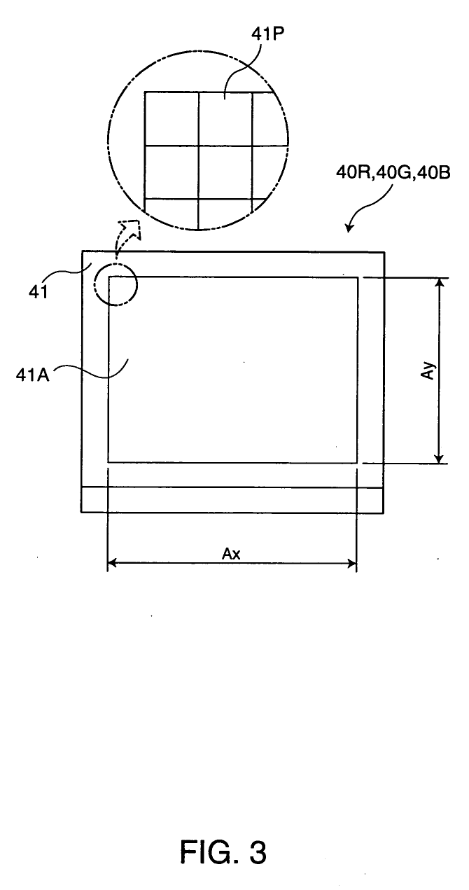

FIG. 3 is a plan view of a liquid crystal light valves 40R, 40G and 40B in the embodiment.

As shown in FIG. 3, each of the liquid crystal light valves 40R, 40G and 40B comprise the liquid crystal panel 41 having a pair of transparent substrates with liquid crystal therebetween. In the inner surfaces of the respective transparent substrates, formed in a matrix in a predetermined area (pixel area 41A which is the area of possible modulation) are transparent electrodes (a pixel electrode) capable of applying a driving voltage to every small area (a pixel 41P) of liquid crystal. The liquid crystal light valves 40R, 40G and 40B in the embodiment have an aspect ratio (Ax:Ay) of 4:3 of the pixel area 41A.

Returning to FIG. 2, the incident-side polarizing plate 42 and the exit-side polarizing plate 43 are adhered to the incident-side surface and the exit-side surface of the liquid crystal panel 41, respectively. The incident-side polarizing plate 42 and the exit-side polarizing plate 43 can respectively transmit only light polarized in a predetermined polarizing direction. The incident-side polarizing plate 42 only transmits light polarized in the polarizing direction which is set by the polarization converting element 14. Accordingly, the incident-side polarizing plates 42 transmit almost all of the light in respective colors incident on the respective liquid crystal light valves 40R, 40G and 40B and the transmitted light is incident on the liquid crystal panel 41.

When a driving voltage is applied to each of the pixels 41P of the liquid crystal panel 41 in accordance with the image signal, the light incident on the pixel area 41A of the liquid crystal panel 41 is modulated in accordance with the driving voltage so that polarized lights of the pixels 41P have polarization direction differing among themselves. Among the various polarized directions of the light, only the polarizing component capable of transmission through the exit-side polarizing plate 43 exits from the liquid crystal light valves 40R, 40G and 40B. That is to say, the transmitivity of incident light through the liquid crystal light valves 40R, 40G and 40B is different among the pixels 41P in accordance with the image signal received by each, and thereby, optical images having gradation are formed for the light in the respective colors. The optical images formed from the light in respective colors emitted from the liquid crystal light valves 40R, 40G and 40B are incident on a cross dichroic prism 50.

The dichroic prism 50 compounds the optical images in the respective colors emitted from the liquid crystal light valves 40R, 40G and 40B for one pixel 41P to form an optical image showing a color image. The optical images compounded by the cross dichroic prisms 50 are enlarged and projected by the projection lens 60, and then, a projected image is displayed on a screen SC or the like.

On the other hand, the controlling unit 3 comprises a controlling part 70, a storage part 71, an operation part 72, a receiver 73, an image quality adjusting part 74, an image processing part 75, an OSD (on-screen display) processing part 76 and a light valve driving part 77, as shown in FIG. 1.

The controlling part 70 is connected to the above respective parts 71, 72 and 74 to 76. The controlling part 70 is formed from a CPU (central processing unit), which is used as a computer, and serves to control an operation of the projector 1 in accordance with the controlling program stored in the storage part 71. The controlling part 70 comprises an area changing part 70a and an area moving part 70b, which can output a controlling signal to communicate the specifics of the processing to the image processing part 75.

The storage part 71 comprises a memory such as a flash ROM (read only memory). The storage part 71 stores the controlling program and is used for storing various kinds of setting values and such.

The operation part 72 is provided with a switch, a key and the like for carrying out various kinds of operations for the projector 1 such as on and off of the power source and adjustment of the picture quality. When a user operates the operation part 72, the operation part 72 outputs an operation signal corresponding to the operation specified, to the controlling part 70.

The receiver 73 receives an input of analog or digital image signal from an external image supplying unit (not shown). The inputted image signal is converted into image data showing gradation for every color (R, G and B) and then supplied to the image quality adjusting part 74.

The image quality adjusting part 74 performs adjustment of brightness, contrast, sharpness and gradation of colors and the like for the inputted image data on the basis of an instruction from the controlling part 70 and outputs the data to the image processing part 75.

The image processing part 75 converts the inputted image data on the basis of an instruction from the controlling part 70, namely, a controlling signal from the area changing part 70a and the area moving part 70b to obtain a gradation value corresponding to the liquid crystal light valves 40R, 40G and 40B of each of the pixels 41P. This allows the image processing part 75 to generate image data from the gradation values of all the pixels 41P.

The controlling signal outputted from the area changing part 70a includes size information comprising electronic zoom information showing an enlargement/reduction rate (a zoom magnification) of the electronic zooming function, aspect ratio information showing an aspect ratio of a projected image, trapezium distortion compensating information for compensating trapezium distortion of a projected image and such. The controlling signal outputted from the area moving part 70b includes location information showing a location for projecting an optical image.

The image processing part 75 changes a size and a shape of an area in order to form an image corresponding to the image data in the pixel area 41A of the liquid crystal light valves 40R, 40G and 40B (a forming area) on the basis of the size information to achieve the electronic zooming function, an aspect ratio changing function and a trapezium distortion compensating function. The image processing part 75 also can change a location of the projected image by moving a location of the forming area in the pixel area 41A on the basis of the location information. Accordingly, the area changing part 70a and the image processing part 75 function as a forming area changing unit of the invention while the area moving part 70b and the image processing part 75 function as a forming area moving unit of the invention.

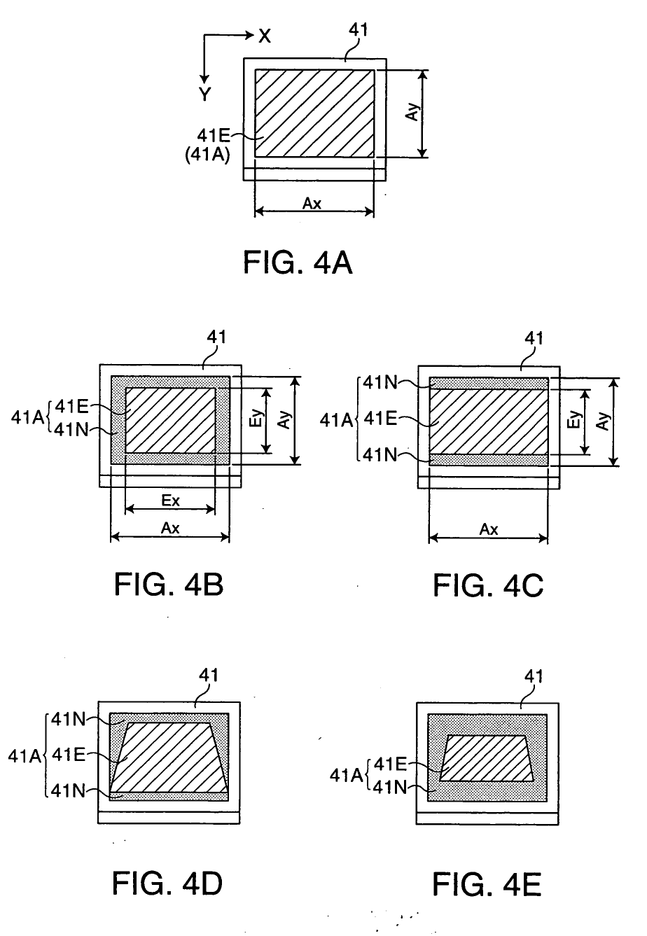

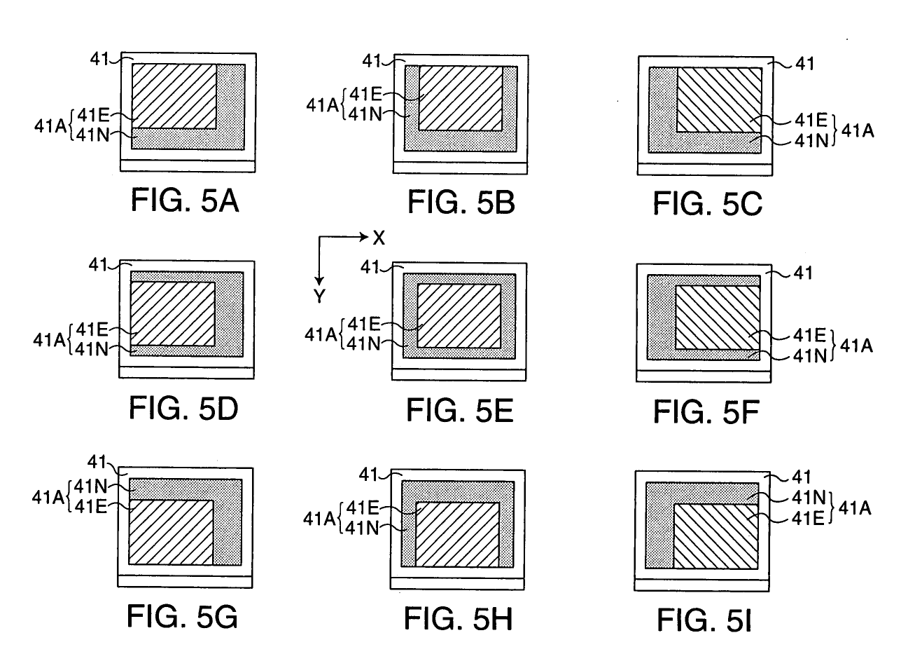

FIGS. 4A to 4E and FIGS. 5A to 5I illustrate processes in the image processing part 75. FIG. 4 illustrates a process according to the size information. FIG. 5 illustrates a process according to the location information. Both of FIGS. 4 and 5 show the liquid crystal light valves 40R, 40G and 40B in a front view of the incident side of the light from the light source.

For example, in the case that the size information from the area changing part 70a indicates that the enlargement/reduction rate of the electronic zoom is the maximum (100%), the aspect ratio is 4:3 and the trapezium distortion is not compensated, the image processing part 75 makes the whole image area 41A the forming area 41E (refer to FIG. 4A).

When the enlargement/reduction rate of the electronic zoom is below the maximum, an area in the size corresponding to the enlargement/reduction rate (Ex/Ax) is made the forming area 41E (refer to FIG. 4B). When the aspect ratio is 16:9, an area whose aspect ratio (Ax:Ey) is 16:9 is made the forming area 41E (refer to FIG. 4C). In the case of trapezium distortion compensation with the aspect ratio of 4:3, the trapezoid of the forming area 41E is made a rectangle with the aspect ratio of 4:3 (refer to FIG. 4D). FIG. 4E shows the forming area 41E in the case of trapezium distortion compensation with the enlargement/reduction rate of the electronic zoom below the maximum and the aspect ratio of 16:9.

The location information from the area moving part 70b shows a location of the forming area 41E in the pixel area 41A. In the embodiment, it is possible to designate as a location of the forming area 41E any one of a total of nine locations (3×3) comprising three locations in the X direction of the image area 41A and three locations in the Y direction, as shown in FIGS. 5A to 5I. FIG. 5E shows the forming area 41E located at the center part of the pixel area 41A. FIGS. 5A, 5C, 5G and 5I show the forming area 41E located at the respective corners of the pixel area 41A. A corner of the forming area 41E is congruent with a corner of the pixel area 41A when the trapezium distortion is not carried out. FIGS. 5B, 5D, 5F and 5H show the forming area 41E located so as to come in contact with a side of the pixel area 41A. The middle point of a side of the forming area 41E is accorded with the middle point of a side of the pixel area 41A in the case that the trapezium distortion is not carried out.

As described above, after determining the size, shape and location of the forming area 41E in the pixel area 41A of the liquid crystal light valves 40R, 40G and 40B, the image processing part 75 carries out a thinning-out process or a supplementing process on the inputted image data to generate a gradation value corresponding to each of the pixels 41P of the forming area 41E. Further, the image processing part 75 generates image data comprising the gradation value of all the pixels 41P in the image area 41A with the gradation value of the pixel 41P of a null area 41N not contributing to forming an image (an area other than the forming area 41E in the pixel area 41A) being 0 (the value at which the transmittivity is the minimum). The image processing part 75 then outputs the generated image data to the OSD processing part 76.

The OSD processing part 76 performs a process for superimposing an OSD image comprising a menu image, a message image and the like on an image corresponding to the image data (refer to as a “display image”, hereinafter) in accordance with an instruction from the controlling part 70. Concretely, the OSD processing part 76 reads out ODS image data indicating the OSD image from an OSD memory (not shown) to generate image data by compounding the image data inputted from the image processing part 75 and the OSD image data, and then, outputs the generated image data to the light valve driving part 77. In the case that the OSD image is not displayed, the above compounding process is not carried out, and therefore, display image data outputted from the image processing part 75 is supplied to the light valve driving part 77 as it is.

The light valve driving part 77 drives the liquid crystal light valves 40R, 40G and 40B on the basis of the image data inputted from the OSD processing part 76. That is to say, driving voltage corresponding to the respective gradation values is applied to the respective pixels 41P of the pixel areas 41A so that images are formed in the forming areas 41E of the liquid crystal light valves 40R, 40G and 40B. When the light from the light source illuminates the liquid crystal light valves 40R, 40G and 40B, a projected image is displayed on the screen SC.

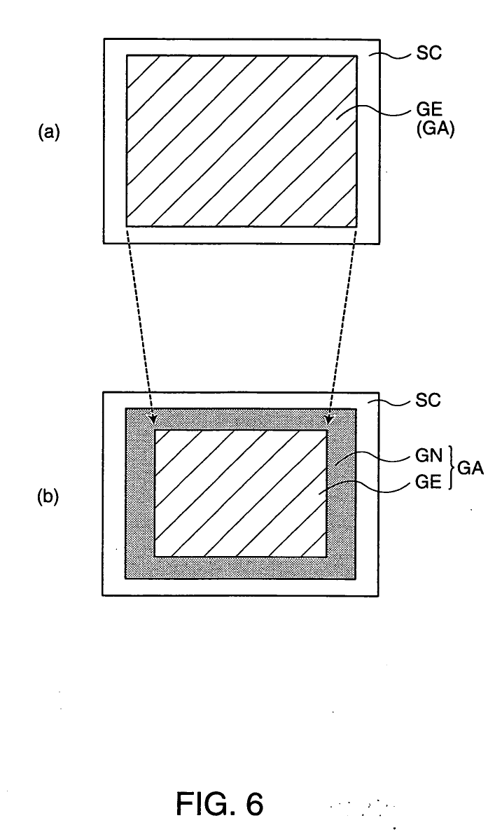

FIGS. 6A and 6B are front views showing a projected image displayed on the screen SC. FIG. 6A shows a case that the enlargement/reduction rate of the electronic zoom is 100%. FIG. 6B shows a case that the enlargement/reduction rate is below 100%.

When the enlargement/reduction rate of the electronic zoom is the maximum (100%), the aspect ratio is 4:3 and the trapezium distortion is not compensated (refer to FIG. 4A), the whole pixel area 41A is the forming area 41E. In this case, a display image GE is displayed all over the illumination area of the light transmitted by the pixel area 41A (refer to as a “projection area GA”) on the screen SC, as shown in FIG. 6A. When the enlargement/reduction rate of the electronic zoom is below the maximum (refer to FIG. 4B), the display image GE is displayed in a size smaller than that of the projection area GA and an area GN outside the display image GE in the projection area GA becomes a black area with almost no illumination of the light, as shown in FIG. 6B, since the area GN corresponds to the null area 41N where the transmittivity of the pixel 41P is set to be the minimum.

It is arranged that an instruction from a user operating the operation part 72 allow all of the above-mentioned electronic zooming function, the aspect ratio changing function and the trapezium distortion compensating function to be carried out.

Now, an operation of the projector 1 will be described, making reference to the drawings. When execution of an operation for changing the forming area 41E such as a change in electronic zoom or aspect ratio or trapezium distortion compensation on the basis of an operational signal from the operation part 72 results in a condition where the forming area 41E is movable, the projector 1 in the embodiment informs a user of a matter that the forming area 41E, namely, the display image GE is movable, and then, the projector 1 requests the user to input a moving direction. When the user gives an instruction of the moving direction in accordance with the information, the projector 1 moves the forming area in the instructed direction to perform a change in projection location of the display image GE (refer to as an “image shift”, hereinafter).

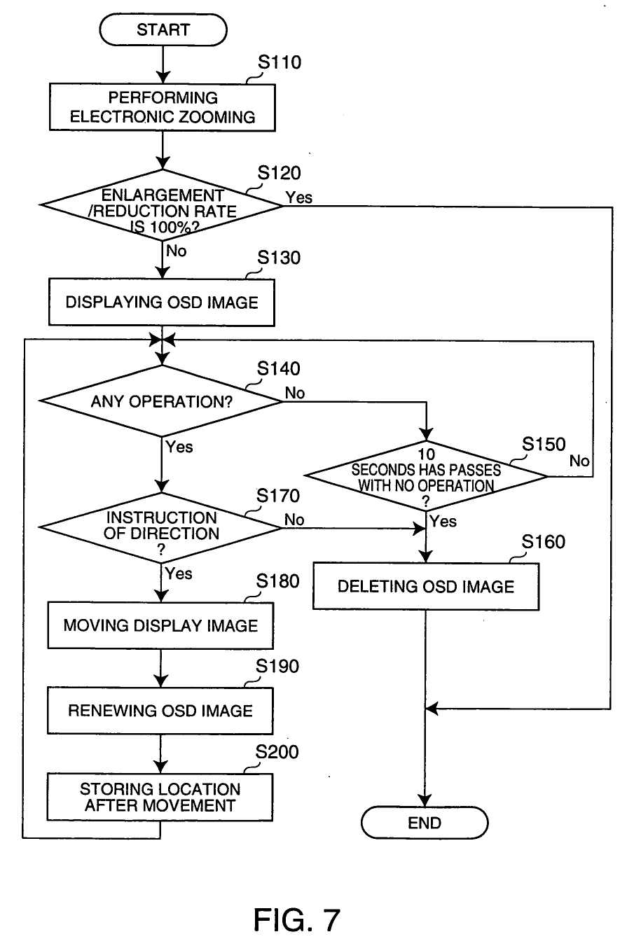

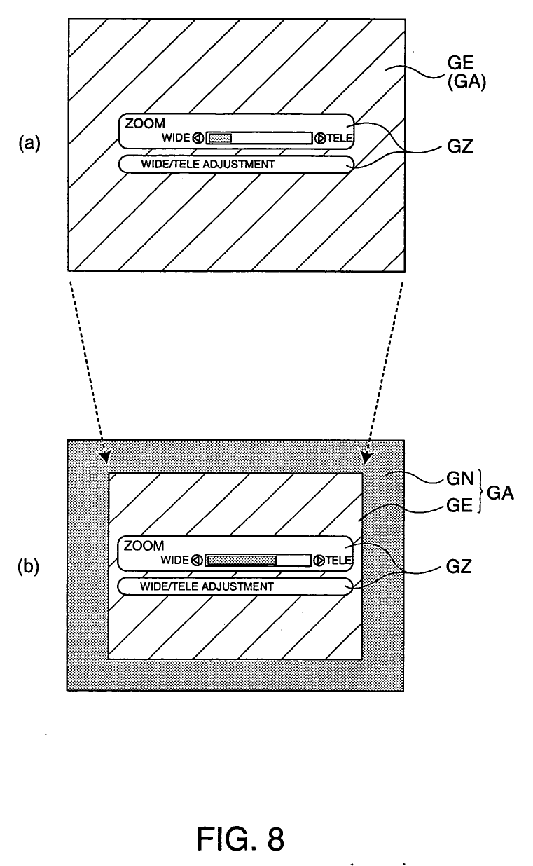

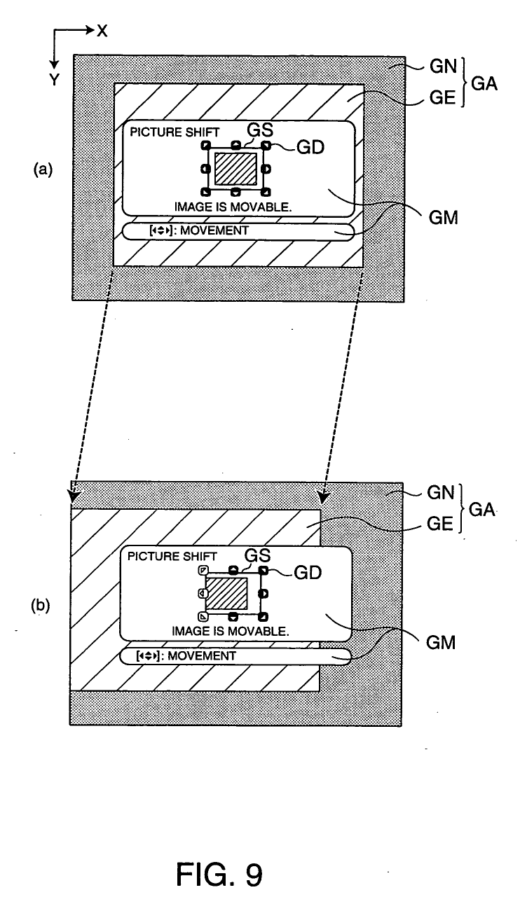

FIG. 7 is a flowchart showing an operation of the projector 1 in carrying out the electronic zooming function. FIGS. 8A and 8B and FIGS. 9A and 9B illustrate projection images displayed in performing the electronic zooming function. When the projector 1 projects an optical image in the whole pixel area 41A, for example, while a user operates the operation part 72 to give an instruction for performing the electronic zoom, the controlling part 70 recognizes the instruction on the basis of a control signal from the operation part 72 to operate in accordance with the flow shown in FIG. 7.

As shown in FIG. 7, in Step S110, carried out is the electronically zooming function according to the instruction from a user. Concretely, the controlling part 70 instructs the OSD processing part 76 to display an OSD image GZ for carrying out the electronic zoom, as shown in FIG. 8A. In accordance with the OSD image GZ, a user can recognize the zooming condition of the display image GE (the enlargement/reduction rate), and the zooming condition can be changed by a “wide” key or a “tele” key provided in the operation part 72.

When the user uses the “wide” key or the “tele” key of the operation part 72 to perform the zooming operation in accordance with guidance of the OSD image GZ, the controlling part 70 outputs electronic zoom information, produced by the area changing part 70a, corresponding to the specific operation to be carried out to the image processing part 75. As shown in FIG. 8B, for example, changing the size of the forming area 41E in accordance with the electronic zoom information produced by the image processing part 75 allows the display image GE to be enlarged or reduced, and thus, the display image GE is reduced in size with respect to the projection area GA. The user can repeatedly carry out the zooming operation until the display image GE comes to a desired size. After a predetermined time (around 3 minutes, for example) has past without any zooming operation, however, the controlling part 70 judges that the zooming operation has been completed to complete display of the OSD image GZ, and then, the process goes to Step S120.

In Step 120, the controlling part 70 judges whether the zooming condition (the enlargement/reduction rate) after the zooming operation by the user is 100% or not. The enlargement/reduction rate of 100% means that the whole pixel area 41A forms an image. In this case, the forming area 41E cannot be moved. Accordingly, the process is completed. When the enlargement/reduction rate after the zooming operation is below 100%, that is, when the forming area 41E is smaller than the pixel area 41A, the forming area 41E can move in the pixel area 41A. Accordingly, the process goes to Step S130 to carry out an operation for changing the projection location of the display image GE.

In Step 130, the controlling part 70 instructs the OSD processing part 76 to display the OSD image GM for the image shift, as shown in FIG. 9A. The OSD image GM includes contents for notifying that the display image GE can be moved by means of a direction instruction key provided in the operation part 72 and an illustration GS showing a size and/or a location of the display image GE with respect to the projection area GA. That is to say, the controlling part 70 and the OSD processing part 76 function as an informing unit for notifying that a location of the display image GE, namely, the forming area 41E is changeable. The OSD image GM allows the user to recognize that the display image GE is movable. Further, the OSD image GM includes eight arrows GD showing directions in which the display image GE can move. This means that the display image GE can be moved in any one of the eight directions indicated by the arrows GD. That is to say, the controlling part 70 and the OSD processing part 76 also function as a guiding unit for giving information of a location or a direction in which the display image GE, namely, the forming area 41E can move.

In Step S140, the controlling part 70 monitors the operation signal from the operation part 72 to judge whether a user performs any operation or not. The process goes to Step S150 when no operation has been carried out while the process goes to Step S170 when any operation is performed.

In the case that the process goes to Step S150 without any operation, the controlling part 70 judges whether or not a predetermined time (ten seconds, for example) has passed with no operation being carried out. When the predetermined time has not yet passed, the process goes to Step S140 while it goes to Step S160 when the predetermined time has passed.

In the case that the process goes to Step S160 after the predetermined time has passed without any operation, the controlling part 70 judges that the image shift operation is completed, and then, deletes the OSD image GM displayed in Step S130 to complete the process.

When the process goes to Step S170 after any operation has been carried out in Step S140, the controlling part 70 judges whether or not the operation is an operation carried out by means of the direction instructing key. In the case of it is an operation carried out by means of the direction instructing key, the process goes to Step S180. In the case it is an operation carried out by means other than the direction instructing key, the image shift operation is judged to be completed, so that the process goes to Step S160 to delete the OSD image GM and the process is completed.

In the case that the direction instructing key is operated and the process goes to Step S180, the controlling part 70 judges that the operation carried out by means of the direction instructing key means an instruction of the moving direction of the display image GE. The controlling part 70 outputs the moving direction in the form of location information to the image processing part 75, changing the form by means of the area moving part 70b. The image processing part 75 changes the location of the forming area 41E with respect to the pixel area 41A on the basis of the location information, so that the projection location of the display image GE is changed.

For example, when a user uses the direction instructing key to give an instruction that the display image GE is moved to the left (in a −X direction), the image processing part 75 changes the location of the forming area 41E so that the forming area 41E would be in contact with a left side border of the pixel area 41A, as shown in FIG. 5D. As a result, the display image GE is moved to the location in contact with the left side border of the projection area GA so as to be displayed as shown in FIG. 9B.

The user can continuously operate the direction instructing key to change the projection location successively. The forming area 41E, however, cannot be moved to the left side any more after it is moved to the location in contact with the left side border of the pixel area 41A (refer to FIG. 5D). Accordingly, in Step S190 the controlling part 70 instructs the OSD processing part 76 to renew the OSD image GM which is displayed at that time, for the purpose of clearly indicating a movable directions by the OSD image GM. Concretely, the controlling part 70 distinguishes directions in which the image is movable and those in which it is not movable based on the current projection location, and informs the OSD processing part 76 of this. The OSD processing part 76 changes the display color of the arrow GD indicating the direction the image cannot be moved into an inconspicuous color and thereby displays the OSD image GM again, as shown in FIG. 9B. This allows the user to easily recognize the directions in which the image can be moved from the current projection location.

In Step S200, the controlling part 70 stores location information indicating the location of the display image GE in the storing part 71. The process then goes back to Step S140 to wait for an operation by the user. When an operation by the direction instructing key is further carried out, the display image GE is moved in accordance with the instruction. When another operation is carried out or no operation is performed within the predetermined time, the OSD image GM is deleted to complete the process. In the above case, the location information is stored in the storing part 71, and therefore, reading out the location information at the subsequent starting time of the projector 1 allows the projection location to be reproduced.

When a user performs an operation for giving an instruction to move in a direction that is not allowed in Step S170, the program returns to Step S140 without carrying out the moving process in Step S180 although this is not shown in the drawings.

In the embodiment, it is arranged that enlargement/reduction be carried out in accordance with the projection location of the display image GE in performing the electronic zooming function in Step S110.

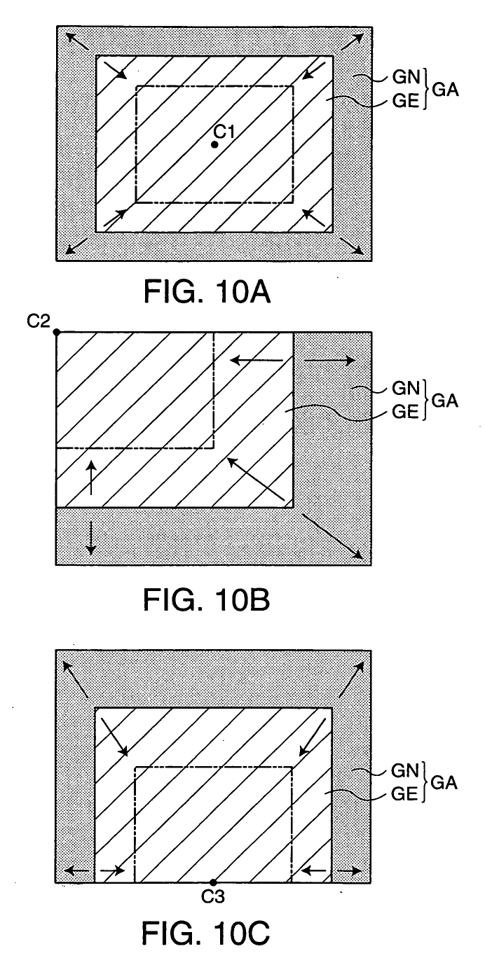

FIG. 10 illustrates a zooming operation performed according to the projection location of the display image GE. FIG. 10 is a front view of the display image GE projected on the screen SC or the like.

For example, when the display image GE is located at the center of the projection area GA as shown in FIG. 10A, the display image GE is enlarged/reduced in size with the center point C1 of the projection area GA being used as a reference point. The display image GE is enlarged/reduced with a vertex C2 of a corner part of the projection area GA being used as a reference point when the display image GE is located at the corner part, as shown in FIG. 10B. In the case that one side of the display image GE and one side of the projection area GA are in contact with each other so that the respective center points of the sides coincide with each other, as shown in FIG. 10C, the enlargement/reduction is carried out with the center points C3 being used as a reference point. Even after the display image GE is enlarged with each of the points C1 to C3 being used as a reference point and the enlargement/reduction rate becomes 100%, to perform reduction with the reference points being used for the purpose of carrying out reduction the preceding reference points, C1 to C3 are reproduced on the basis of the location information stored in the storing part 71.

Further, in the embodiment, in order to carry out an aspect ratio change or trapezium distortion compensation, the OSD image GM is displayed and the image shift of the display image GE is made. In this case, even when the enlargement/reduction rate is 100%, since the image shift is possible even when the enlargement/reduction rate is 100% (the image shift is possible in the vertical direction (±the Y direction) under the condition shown in FIGS. 4C and 4D, for example), the controlling part 70 distinguishes movable directions on the basis of the shape of the null area 41N existing on the periphery of the forming area 41E after the aspect ratio change or the trapezium distortion compensation, and executes the process from Step S130 on.

As described above, the following effect can be achieved in accordance with the projector 1 according to the embodiment.

(1) In accordance with the projector 1 in the embodiment, when the forming area 41E is movable in the pixel area 41A after the change in size or shape of the forming area 41E by the image processing part 75, the location information indicating a moving direction is inputted by the operation part 72 so that the image processing part 75 will move the forming area 41E on the basis of the location information. As a result, a user can move the forming area 41E, namely, the display image GE, by operating the operation part 72, and thereby, can easily change the location of the display image GE.

(2) In accordance with the projector 1 in the embodiment, when the forming area 41E is movable in the pixel area 41A after the change in size or shape of the forming area 41E by the image processing part 75, the OSD processing part 76 gives information that the forming area 41E, namely, the display image GE is movable. This allows a user to easily recognize that the display image GE is movable.

(3) In accordance with the projector 1 in the embodiment, when the forming area 41E is movable in the pixel area 41A after the change in size or shape of the forming area 41E by the image processing part 75, the OSD processing part 76 gives information to request input of a moving direction. This allows the change in size or shape of the forming area 41E and the movement of the forming area 41E to be carried out in succession, so that convenience in changing the location of the display image GE is improved.

(4) In accordance with the projector 1 in the embodiment, the OSD image GM gives information of a direction in which the forming area 41E, namely, the display image GE, is movable when input of the moving direction is requested. Accordingly, a user can easily recognize the movable location and direction, so that convenience in changing the location of the display image GE is further improved.

(5) In accordance with the projector 1 in the embodiment, the OSD processing part 76 displays an illustration GS showing a size and/or a location of the display image GE with respect to the projection area GA in performing the image shift. Accordingly, the location of the display image GE with respect to the projection area GA can be recognized even in the case that the whole display image GE is black such as a case that no image signal is inputted. This allows convenience in performing the image shift to be improved.

Modification:

The embodiment of the invention can be modified as described below.

In the embodiment, the moving direction can be instructed by the operation part 72, but the location information inputted by the operation part 72 is not limited to the moving direction. Any one of nine places at which the forming area 41E can be located can be directly designated, for example.

In the embodiment, it is arranged that any one of nine places in the pixel area 41A can be selected to move the forming area 41E. The moving method of the forming area, however, is not limited to the above. The forming area 41E may be arranged to be movable by moving one pixel at a time or a predetermined number of pixels at a time, for example. This allows the location of the display image GE to be adjusted more minutely.

In the embodiment, the image shift can be carried out after performing the electronic zooming, the aspect ratio change or the trapezium distortion compensation. The timing for performing the image shift, however, is not limited to the above. It may be possible, for example, that a user operates the operation part 72 to execute the program following to Step S130 in predetermined timing.

In the embodiment, operating the operation part 72 by a user to give an instruction allows the electronic zooming function, the aspect ratio changing function, and trapezium distortion compensating function be performed. It may be arranged, however, that an aspect ratio recognizing unit capable of recognizing an aspect ratio of an inputted image signal is provided to enable an aspect ratio of the projected image to be changed in accordance with an input of the image signal, for example. It may be also arranged that an inclination detecting unit capable of detecting an inclination of the projector and a trapezium distortion detecting unit capable of recognizing the shape of the projected image be provided to perform trapezoid distortion compensation in accordance with the detecting operation.

Further, the program from Step S130 onward may be executed when the forming area 41E can move in the pixel area 41A after the aspect ratio change or the trapezium distortion compensation is carried out as described above.

In the above embodiment, the OSD image GM is used for notifying that the display image GE (the forming area 41E) is movable and giving the movable directions. The invention, however, is not limited to the above. A display apparatus or the like, which is capable of giving such information, may be provided in the projector 1. The information may be given by means of a sound.

In the embodiment, the liquid crystal light valves 40R, 40G and 40B are used as an optical modulation unit. LCOS (liquid crystal on silicon), a reflection type optical modulation unit, however, may be used. It is also possible to use DMD (digital micro-mirror device) (a registered trademark of Texas Instruments) for modulating light emitted from a light source by controlling the exit direction of light incident on each micro-mirror, which is used as one pixel.

What is claimed is:

1. A projector in which an image signal is inputted to project an optical image corresponding to the image signal and display the image on a projection surface, the projector comprising:
an optical modulation unit having an area of possible modulation where light emitted from a light source can be modulated within the area of possible modulation to form an optical image;
a projection lens for enlarging and projecting the optical image formed in the optical modulation unit;
a forming area changing unit capable of changing a size or a shape of a forming area in which is formed an optical image corresponding to the image signal in the area capable of optical modulation;
an operation part capable of inputting location information indicating a projection location of the optical image corresponding to the image signal; and
a forming area moving unit for moving the forming area on the basis of the location information inputted by the operation part when the forming area changed in size or shape by the forming area changing unit is movable in the area of possible modulation.

2. The projector according to claim 1, comprising:
a notifying unit for notifying that the projection location of the optical image corresponding to the image signal can be changed after the size or shape of the forming area is changed by the forming area changing unit so that the forming area can move in the area of possible modulation.

3. The projector according to claim 2, wherein the notifying unit incorporates in the projected image the information for displaying the image.

4. A projector in which an image signal is inputted, and which projects an optical image corresponding to the image signal on a projection surface for display, the projector comprising:
an optical modulation unit having an area of possible modulation where light can be modulated, and which modulates the light emitted from a light source within the area of possible modulation to form an optical image;
a projection lens for enlarging and projecting the optical image formed in the optical modulation unit;
a forming area changing unit capable of changing a size or a shape of a forming area in order to form an optical image corresponding to the image signal in the area of possible modulation;
an operation part capable of inputting location information indicating a projection location of the optical image corresponding to the image signal; and
a notifying unit for notifying that the projection location of the optical image corresponding to the image signal can be changed and for requesting an input of the location information when the forming area whose size or shape has been changed by the forming area changing unit is movable in the area of possible modulation; and
a forming area moving unit for moving the forming area on the basis of the location information inputted by the operation part.

5. The projector according to claim 4, wherein the notifying unit incorporates in the projected image the information for displaying the image.

6. The projector according to claim 4, comprising:
a guiding unit for giving information of a location or a direction in which the optical image corresponding to the image signal can move when the forming area whose size or shape has been changed by the forming area changing unit is movable in the area of possible modulation.

7. The projector according to claim 6, wherein the guiding unit incorporates in the projected image the information for displaying the image.

8. A projector in which an image signal is inputted, which projects an optical image corresponding to the image signal on a projection surface for display, the projector comprising:
an optical modulation unit having an area of possible modulation where light can be modulated, and which modulates the light emitted from a light source within the area of possible modulation to form an optical image;
a projection lens for enlarging and projecting the optical image formed in the optical modulation unit;
an operation part capable of inputting size information indicating a size or a shape of the optical image corresponding to the image signal and location information indicating a projection location of the optical image;
a forming area changing unit for changing a size or a shape of a forming area in which is formed an optical image corresponding to the image signal within the area capable of optical modulation, in accordance with the size information inputted from the operation part;
a notifying unit for notifying that the projection location of the optical image corresponding to the image signal can be changed and for requesting an input of the location information, when the forming area whose size or shape has been changed by the forming area changing unit is movable in the area of possible modulation; and
a forming area moving unit for moving the forming area on the basis of the location information inputted by the operation part.

9. A method of controlling a projector comprising an optical modulation unit having an area of possible modulation where light can be modulated, and which modulates the light emitted from a light source to the area of possible modulation to form an optical image; and
a projection lens for enlarging and projecting the optical image formed by the optical modulation unit, the projector projecting the optical image corresponding to an inputted image signal on a projection surface for display, the method including:
changing a size or a shape of a forming area in order to form an optical image corresponding to the image signal in the area of possible modulation;
inputting location information indicating a projection location of the optical image corresponding to the image signal; and
moving the forming area on the basis of the location information inputted when the forming area changed in size or shape so as to be movable in the area of possible modulation.

10. A method of controlling a projector comprising:
an optical modulation unit having an area of possible modulation where light can be modulated, and which modulates the light emitted from a light source within the area of possible modulation to form an optical image; and a projection lens for enlarging and projecting the optical image formed by the optical modulation unit, the projector projecting an optical image corresponding to an inputted image on a projection surface for display, the method including:
changing a size or a shape of a forming area in order to form an optical image corresponding to the image signal within the area of possible modulation;
notifying that the projection location of the optical image corresponding to the image signal can be changed and requesting an input of location information indicating the projection location, when the forming area is changed in size or shape so as to be movable in the area of possible modulation;
inputting the location information; and
moving the forming area on the basis of the location information inputted.

11. A method of controlling a projector comprising an optical modulation unit having an area of possible modulation where light can be modulated, and which modulates the light emitted from a light source within the area of possible modulation to form an optical image; and a projection lens for enlarging and projecting the optical image formed by the optical modulation unit, the projector for projecting an optical image corresponding to an inputted image signal on a projection surface for display, the method including:
inputting size information indicating a size or a shape of the optical image corresponding to the image signal;
changing a size or shape of a forming area in order to form the optical image corresponding to the image signal in the area of possible modulation in accordance with the size information inputted;
notifying that the projection location of the optical image corresponding to the image signal can be changed and requesting an input of location information indicating the projection location, when the forming area which has been changed in size or shape is movable in the area of possible modulation;
inputting the location information; and
moving the forming area on the basis of the location information inputted.
